(19) United States
(12) Patent Application Publication
(10) Pub. No.: US 2017/0085115 A1
(43) Pub. Date: Mar. 23, 2017

(54) METHOD, SYSTEM AND APPARATUS FOR ALTERNATIVE POWER WIRELESS CHARGING

(71) Applicant: Intel Corporation, Santa Clara, CA (US)

(72) Inventors: Lilly Huang, Portland, OR (US); Wayne L. Proefrock, Hillsboro, OR (US); Bernhard Raaf, Neuried (DE); Krishnan Ravichandran, Saratoga, CA (US); Songnan Yang, San Jose, CA (US)

(73) Assignee: Intel Corporation, Santa Clara, CA (US)

(21) Appl. No.: 14/862,627

(22) Filed: Sep. 23, 2015

(51) Int. Cl. H02J 7/02; H02J 7/04; H02J 5/00

(52) U.S. Cl. CPC H02J 7/025; H02J 5/005; H02J 7/04

(57) ABSTRACT

The disclosure generally relates to methods, system and apparatus to wirelessly charge a mobile device using one of conventional or alternative power sources. In an exemplary embodiment, the disclosure provides a method and apparatus to detect power source as a function of its power profile linearity. Once determination is made as to whether the incoming power is harvested from natural resources or is provided from conventional AC/DC adapter/DC source, the incoming power is conditioned and impedance-matched to wirelessly energize an external load. The external load may be a device configured for wireless charging.

### BACKGROUND

Field

The disclosure generally relates to a method, system and apparatus to provide alternative power to wireless charging platforms. Specifically, the specification relates to methods, system and apparatus to wirelessly charge a mobile device using one or more of a conventional or an alternative power source.

Description of Related Art

Wireless charging or inductive charging uses a magnetic field to transfer energy between two devices. Wireless charging can be implemented at a charging station. The two leading wireless charging standards are Qi and the Alliance for Wireless Power (A4WP). The Qi standard uses magnetic inductive coupling within a close range between devices (e.g., about 4 cm) to provide near field wireless transfer between devices. A4WP provides a much larger magnetic field by using magnetic resonance coupling between the devices. Under both standards, energy is sent from one device to another device through an inductive coupling. The inductive coupling is used to charge batteries or to run the receiving device. The inductive energy is provided by a Power Transmitting Unit (PTU) to a Power Receiving Unit (PRU).

The A4WP defines five categories of PRU parameterized by the maximum power delivered out of the PRU resonator. Category 1 is directed to lower power applications (e.g., Bluetooth headsets). Category 2 is directed to devices with power output of about 3.5 W and Category 3 devices have an output of about 6.5 W. Categories 4 and 5 are directed to higher-power applications (e.g., tablets, netbooks and laptops).

A PTUs uses an induction coil to generate a magnetic field from within a charging base station. A second induction coil in the PRU (i.e., portable device) takes power from the magnetic field and converts the power back into electrical current to charge the battery. In this manner, the two proximal induction coils form an electrical transformer. Greater distances between sender and receiver coils can be achieved when the inductive charging system uses magnetic resonance coupling. Magnetic resonance coupling is the near field wireless transmission of electrical energy between two coils that are tuned to resonate at the same frequency.

Wireless charging is particularly important for fast charging of devices including smartphones, tablets and laptops. Conventional wireless chargers supply Alternating Current (AC) or Direct Current (DC) to power the PTU. There is a need for improved wireless charging systems to extend the PTU input power to include sources other than conventional AC/DC.

### BRIEF DESCRIPTION OF THE DRAWINGS

These and other embodiments of the disclosure will be discussed with reference to the following exemplary and non-limiting illustrations, in which like elements are numbered similarly, and where:

FIG. 1A shows a conventional alternative power source for charging a portable device where the charging panel and the computing device are remote from each other;

FIG. 1B shows a conventional alternative power source for charging a portable device where the power source and the computing device are co-located;

FIG. 2 illustrates a conventional wireless power transfer system;

FIG. 3 schematically illustrates a PTU according to one embodiment of the disclosure;

FIG. 4 schematically illustrates a wireless charger according to another embodiment of the disclosure;

FIG. 5 is an exemplary representation of a Hybrid Transmitter Controller according to one embodiment of the disclosure;

FIG. 6 shows an exemplary flow diagram for implementing an embodiment of the disclosure; and

FIG. 7 schematically illustrates wireless charging of a mobile device according to one embodiment of the disclosure.

### DETAILED DESCRIPTION

Certain embodiments may be used in conjunction with various devices and systems, for example, a mobile phone, a smartphone, a laptop computer, a sensor device, a Bluetooth (BT) device, an Ultrabook™, a notebook computer, a tablet computer, a handheld device, a Personal Digital Assistant (PDA) device, a handheld PDA device, an on board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (AV) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing Institute of Electrical and Electronics Engineers (IEEE) standards (IEEE 802.11-2012, IEEE Standard for Information technology-Telecommunications and information exchange between systems Local and metropolitan area networks—Specific requirements Part 11: Wireless LAN Medium Access Control (MAC) and Physical Layer (PHY) Specifications, Mar. 29, 2012; IEEE 802.11 task group ac (TGac) (“IEEE 802.11-09/0308r12—TGac Channel Model Addendum Document”); IEEE 802.11 task group ad (TGad) (IEEE 802.1 lad-2012, IEEE Standard for Information Technology and brought to market under the WiGig brand—Telecommunications and Information Exchange Between Systems—Local and METROPOLITAN Area Networks—Specific Requirements—Part 11: Wireless LAN Medium Access Control (MAC) and Physical Layer (PHY) Specifications—Amendment 3: Enhancements for Very High Throughput in the 60 GHz Band, 28 Dec. 2012)) and/or future versions and/or derivatives thereof, devices and/or networks operating in accordance with existing Wireless Fidelity (Wi-Fi) Alliance (WFA) Peer-to-Peer (P2P) specifications (Wi-Fi P2P technical specification, version 1.2, 2012) and/or future versions and/or derivatives thereof, devices and/or networks operating in accordance with existing cellular specifications and/or protocols, e.g., 3rd Generation Partnership Project (3GPP), 3GPP Long Term Evolution (LTE), and/or future versions and/or derivatives thereof, devices and/or networks operating in accordance with existing Wireless HD™ specifications and/or future versions and/or derivatives thereof, units and/or devices which are part of the above networks, and the like.

Some embodiments may be implemented in conjunction with the BT and/or Bluetooth Low Energy (BLE) standard. As briefly discussed, BT and BLE are wireless technology standard for exchanging data over short distances using short-wavelength UHF radio waves in the industrial, scientific and medical (ISM) radio bands (i.e., bands from 2400-2483.5 MHz). BT connects fixed and mobile devices by building personal area networks (PANs). Bluetooth uses frequency-hopping spread spectrum. The transmitted data are divided into packets and each packet is transmitted on one of the 79 designated BT channels. Each channel has a bandwidth of 1 MHz. A recently developed BT implementation, Bluetooth 4.0, uses 2 MHz spacing which allows for 40 channels.

Some embodiments may be used in conjunction with one way and/or two-way radio communication systems, a BT device, a BLE device, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like. Some demonstrative embodiments may be used in conjunction with a WLAN. Other embodiments may be used in conjunction with any other suitable wireless communication network, for example, a wireless area network, a “piconet”, a WPAN, a WVAN and the like.

Various embodiments of the invention may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

Extended Battery Life on mobile devices is continually driving product design and market demand. The conventional systems rely on the AC grid to power or charge portable devices. Alternative power sources, including g solar panels or other energy harvesters may provide a complimentary power supply. The characteristics of the alternative power sources are different from the conventional power supplies which has prevented an alternative power source to directly replace a conventional power supply in wireless charging.

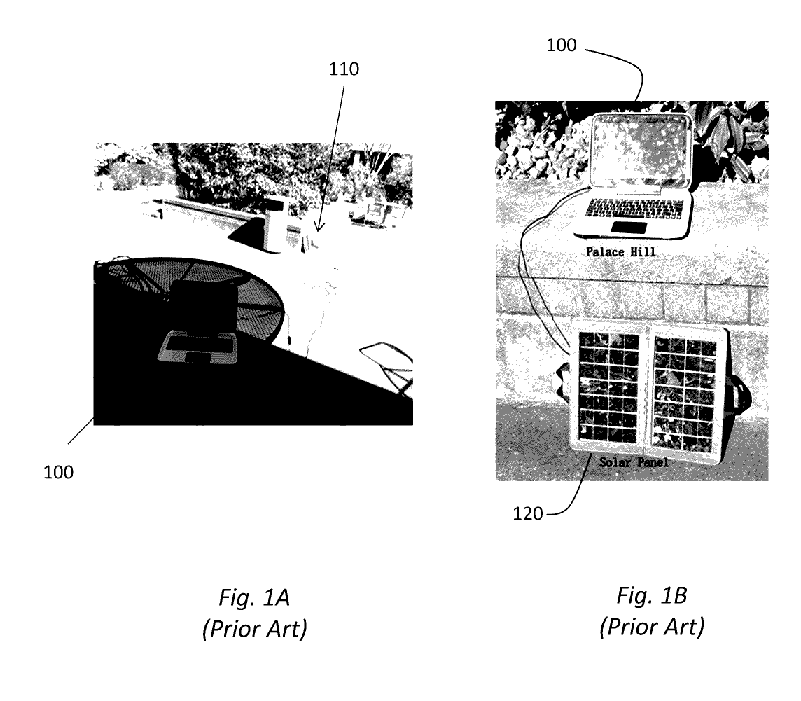

FIG. 1A shows a conventional alternative power source for charging a portable device where the charging panel and the computing device are remote from each other. In FIG. 1A, device 100 is being charged by photovoltaic (PV) source 110. The PV source 110 is positioned to receive direct sunlight. Device 100 is placed in the shade so as to reduce screen glare from direct sunlight. Device 100 and PV source 110 are connected by a wire. The conventional system of FIG. 1A detracts from user experience because PV 110 is placed in direct sunlight order to harvest maximum energy while device 100 is kept away from PV 110 to avoid direct sunlight.

In contrast, FIG. 1B shows a conventional alternative power source for charging a portable device where the power source and the computing device are co-located. Here, a short wire connects the two devices. As shown, there is a substantial glare on the on display 100 which detracts from user experience. The system of FIG. 1B also requires a wire to communicate power to device 100 which further detracts from user experience.

Conventional wireless charging technologies enable wireless charging. However, such systems work on a AC and/or DC input sources. For example, most of the conventional wireless charging tables operate with an AC/DC adaptor and a regulated 12 V DC supply. The conventional power delivery systems do not support input from alternative power sources. This is due to the non-linear power characteristics associated with the alternative power source.

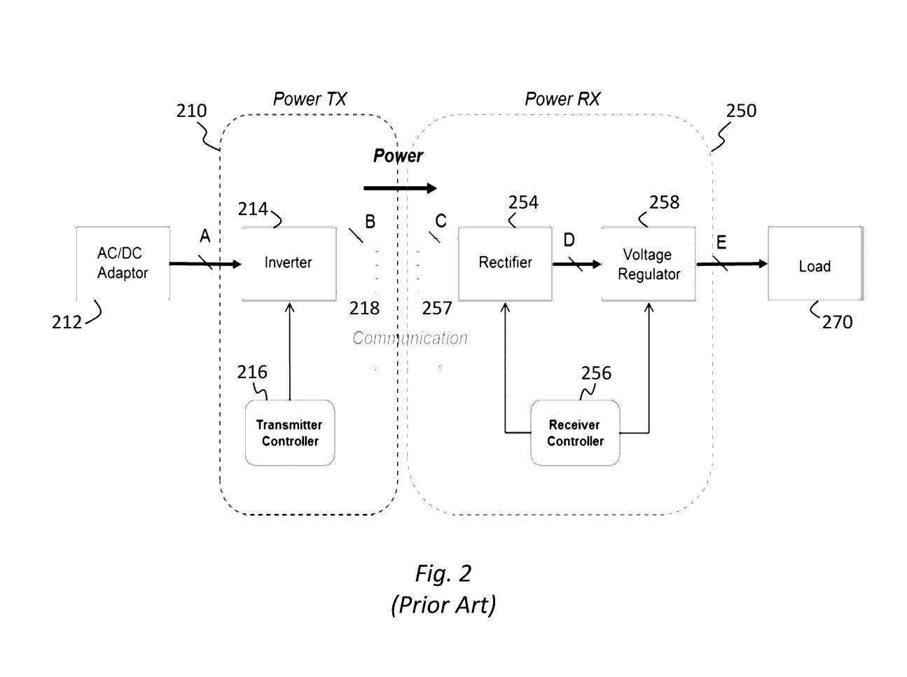

FIG. 2 illustrates a conventional wireless power transfer system. In FIG. 2, AC/DC adaptor 212 communicates with PTU 210. The AC/DC adaptor may be any conventional power supply. PTU 210 includes Inverter 214, Transmitter Controller 216 and Resonator 218. PRU 250 includes Resonator 257, Rectifier 254 and Voltage Regulator 258. Controller 256 of PRU 250 communicates with Controller 216 of PTU 210. The communication may be through BLE packets. The communication includes information that enables PTU 210 to generate optimal magnetic field for charging PRU 250.

During charging operation, Inverter 214 receives input from Controller 216 and conditions magnetic waveform generated by Resonator 218. Magnetic power generated by Resonator 214 of PTU 210 is received by Resonator 258 of PRU 250. Rectifier 254 converts the magnetic signals received at Resonator 254 to DC voltage. Voltage Regulator 258 further conditions the received DC voltage to a constant voltage prior to energizing load 270. Load 270 may define a device under charge (DUC). The conventional PTUs are incapable of efficiently receiving and converting power form alternative sources.

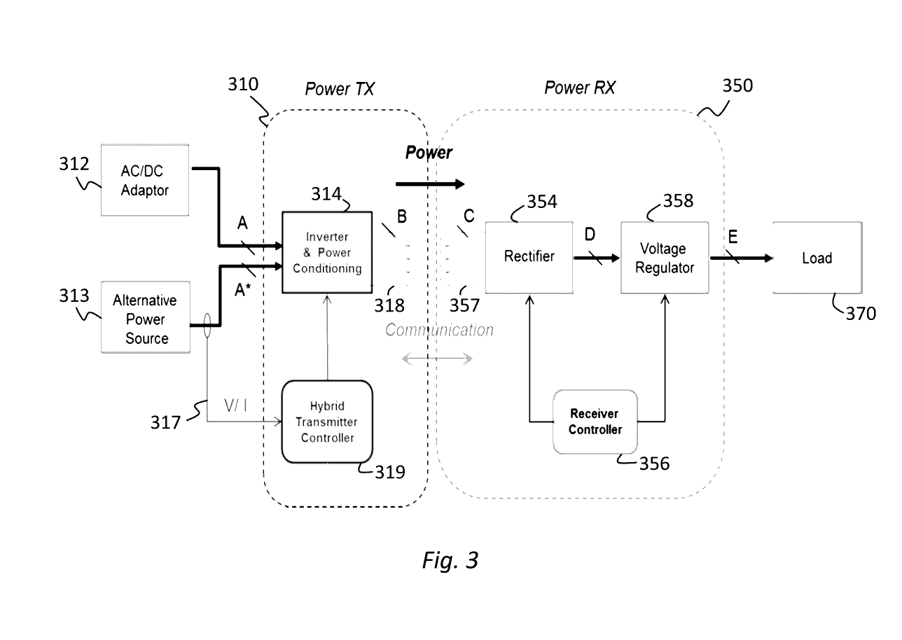

FIG. 3 schematically illustrates a PTU according to one embodiment of the disclosure. PTU 310 of FIG. 3 may receive power from either AC/DC adaptor 312 or from Alternative Power Source 313. Alternative Power Source 313 may include, for example, a photovoltaic source for converting sunlight into energy. Power sources 312, 313 supply energy to Inverter and Power Conditioning Unit 314. The Inverter and Power Conditioning Unit 314 functions as an inverter when the supplied energy is from a AC/DC adaptor. The Inverter and Power Conditioning Unit 314 further conditions incoming energy when PTU 310 is powered by an alternative source. In one embodiment of the disclosure, power conditioning may include conditioning variable input voltage or/and current to a specific value of voltage or/and current at the output. In another embodiment, the a non-uniform input power profile is converted to a substantially uniform power profile. In another embodiment, power conditioning may include matching the impedance of the input power (source) to that of the load which may be a PRU or DUC.

Hybrid Transmitter Controller 319 communicates with PRU 350 as well as Alternative Power Source 313. When the Alternative Power Source 313 is the input source, Hybrid Transmitter Controller 319 may direct Inverter & Power Conditioning Unit 314 to appropriately energize resonator 318.

As with the PRU of FIG. 2, PRU 350 includes Resonator 357, Voltage Regulator 358, Rectifier 354 and Voltage Controller 356. PRU 350 supports load 370. PTU 310 generates magnetic field to wirelessly charge load 370 regardless of whether the PTU is powered by AC/DC adaptor 312 or by Alternative Power Source 313.

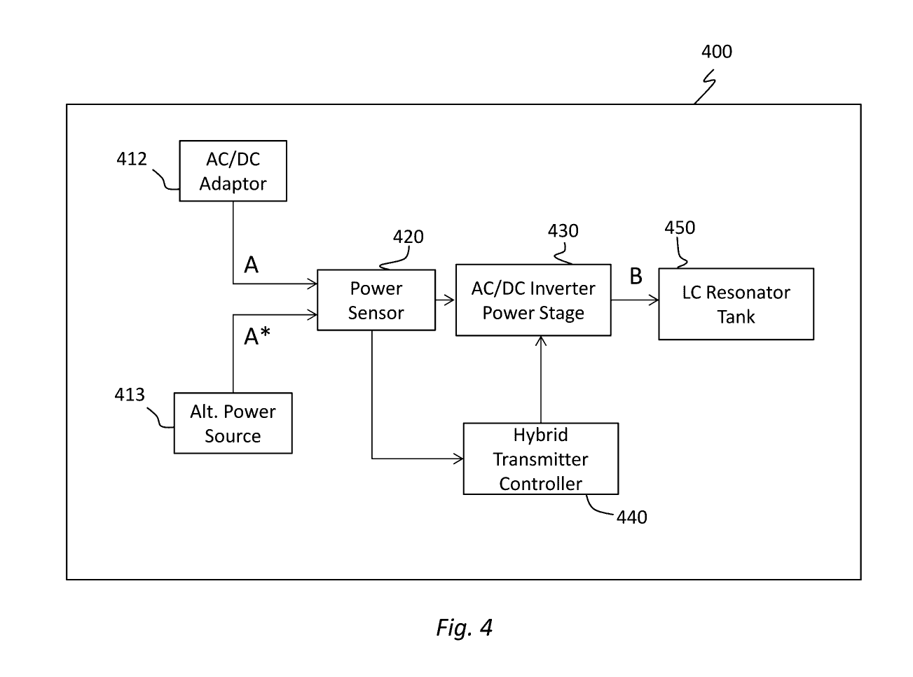

FIG. 4 schematically illustrates a wireless charger according to another embodiment of the disclosure. Specifically, FIG. 4 shows PTU 400 including AC/DC Adaptor 412, Alternative Power Source 413, Power Sensor 420, AC/DC Inverter Power Stage 430, Hybrid Transmitter Controller 440 and Power Transmission LC Resonator Tank 450. While not shown in FIG. 4, PTU 400 may further include additional processing and memory circuitry as well as one or more communication platforms with dedicated radio(s) and antenna(s). AC/DC adaptor may be integrated with PTU 400 or may define an external adaptor for converting AC power input to DC input power for PTU's consumption. The output signal of AC/DC Adaptor 412 is shown as signal A.

PTU 400 also includes Alternative Power Source 413 which may include solar panels or any other power source harvesting natural power. The power output of Alternative Power Source 413 is identified as A* to indicate special current and voltage characteristics. For example, A* may denote non-linear current-voltage profile. Power Sensor 420 receives power signals A or A* and may determine whether the input power is from AC/DC Adaptor 412 or from an Alternative Power Source 413. Once the power source is identified, Power Sensor 420 may communicate the relevant information to Hybrid Transmitter Controller 440.

In exemplary embodiment, power sensor 420 comprises one or more processors (not shown) in communication with a memory circuitry (not shown). The processors and/or the memory circuits may define hardware, software or a combination of hardware and software. As will be discussed in greater detail below, the memory circuitry may comprise instructions and/or algorithms which may be implemented in the processors for source determination. The processors may identify the applicable power source and communicate the information to Hybrid Transmitter Controller 440.

If the input to Power Sensor 420 is from Adaptor 412, then Power Sensor 420 may direct power to AC/DC Inverter Power Stage 430. In addition, Power Sensor 420 may communicate the input power to Hybrid Transmitter Controller 440 so that an appropriate driving signal may be generated by Hybrid Transmitter Controller 440 to drive AC/DC Inverter Power Stage 430.

Conversely, Power Sensor 420 may direct incoming power signal A* to AC/DC Inverter Power Stage 430 and a signal indicating alternative input source may be send to Hybrid Transmitter Controller 440. A different control action may be required to achieve the power condition besides conventional operations. In this embodiment, AC/DC Inverter Power Stage 430 receives appropriate driving signal from the Hybrid Transmitter Controller 440. In one embodiment, only one of source A and source A* may be active at any time.

On the other hand, if power is supplied from Alternative Power Source 413, Power Sensor 420 my implement a different path. Here, characteristics of incoming power (e.g., non-linear current-voltage profile) may be detected by Power Sensor 420 and the incoming power signal directed to Hybrid Transmitter Controller 440. In one embodiment, Power Sensor 420 senses one or more of incoming voltage, current or power characteristics and determines directs power to AC/DC Inverter Power Stage 430 (with either a conventional control method or a different control scheme for an alternative power source) or through Hybrid Transmitter Controller 440. As will be discussed below, Hybrid Transmitter Controller 440 provides power impedance matching and power conditioning to harvest maximum available energy from the incoming power signal (A*).

DC/AC Inverter Power Stage 430 receives and conveys the power output from Hybrid Transmitter Controller 440 to LC Resonator Tank 450. Resonator Tank 450 provides magnetic field to a PRU (not shown). Resonator 450 may comprise one or more resonator coils. While not shown, PTU 400 may also communicate with the PRU through BLE advertising packets or other conventional communication methods. The exemplary embodiment of FIG. 4 enables wireless charging using conventional AC/DC power supply as well as an alternative power source seamlessly. PTU 400 may switch between the various power sources as the input source changes and without user involvement.

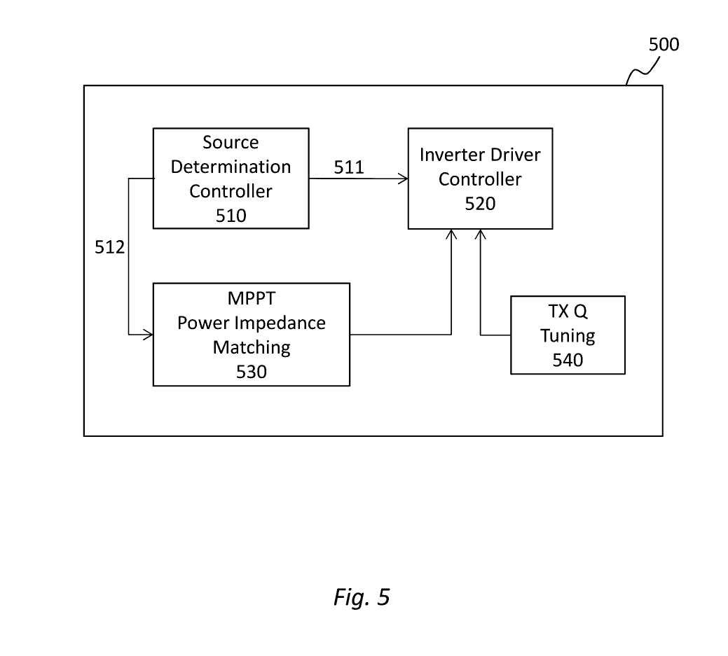

FIG. 5 is an exemplary representation of a Hybrid Transmitter Controller according to one embodiment of the disclosure. Hybrid Transmitter Controller 500 may be used for power conditioning and impedance matching when an alternative power source is used. The alternative power source may include any harvested energy source. Exemplary Controller 500 includes Source Determination Controller 510, Maximum Power Tracking (MPPT) Impedance Matching Circuitry 530, Invert Driver Control 520 and Transmitter Q Tuning circuitry 540.

Source Determination Controller 510 may comprise one or more microprocessor (circuitry and operating algorithm) to determine which of the two control mechanism to select for the incoming power. If the input power is from a DC source (e.g., from AC/DC Adaptor 412 of FIG. 4), then the incoming voltage is substantially constant and will be routed to Inverter Driver Control 520 as shown by path 511. If the input power is harvested from an alternative power source, then Source Determination Controller 510 directs the input power signal through path 512 to MPPT 530.

Power provided by alternative power source (e.g., power source 413, FIG. 4) may have nonlinear current/voltage profile. To provide optimal wireless charging power, such input may be conditioned and impedance-matched. In one embodiment, MPPT 530 manipulates and conditions the incoming power to have a substantially constant voltage. MPPT 530 may also match the impedance of the source to that of the load so as to provide optimal charging environment.

Inverter Driver Control 520 receives power input from either Source Determination Controller 510 (if the input power has constant voltage) or from MPPT circuit 530 (if the power source is harvested). Inverter Control 520 may comprise a conventional DC/AC inverter and other circuitry to provide an appropriate driving signal to the inverter or resonator. Tuning circuitry 540 provides additional tuning input to Inverter Driver circuit 520 to adjust the amount of power being transferred to the resonator.

The exemplary embodiment of FIGS. 4 and 5 advantageously enable using different power sources for wireless charging. In these embodiments, the power characteristics such as nonlinear current/voltage profile can be addressed with MPPT power impedance matching. In turn, this ensure availability of maximum harvested power is supplied to the PRU. More specifically, the disclosed embodiments ensure optimal power input to the TX LC resonant tank (i.e., input B, FIG. 4) and to the PRU. Since LC Resonant T 450 (FIG. 4) and wireless power coupling are manipulated through the same power stage regardless of the input source, the proposed design and control scheme is flexible and cost-effective to apply under DC power supply or an alternative power source. The alternative power source may include harvested energy. Inverter Driver Control unit 520 control may be configured in such a way that it takes into considerations from multiple demands simultaneously among impedance matching, Resonant Tank, Q Tuning 540 and power transfer coupling.

In one implementation, the corresponding power matching between PTU and PRU may be done in an order of time sequence or in a priority manner. For example, at first, the frequency of LC Resonator 450 (FIG. 4) may be adjusted so that the available power would be transferred most efficiently from the TX front-end of the PTU to PRU's resonators. Then, the amount of harvested energy may be maximized through impedance tuning by varying the Pulse-Width-Modulation (“PWM”) duty cycle of driving signal (e.g., Inverter Driver 520, FIG. 5) of the inverter (e.g., Inverter 430, FIG. 4).

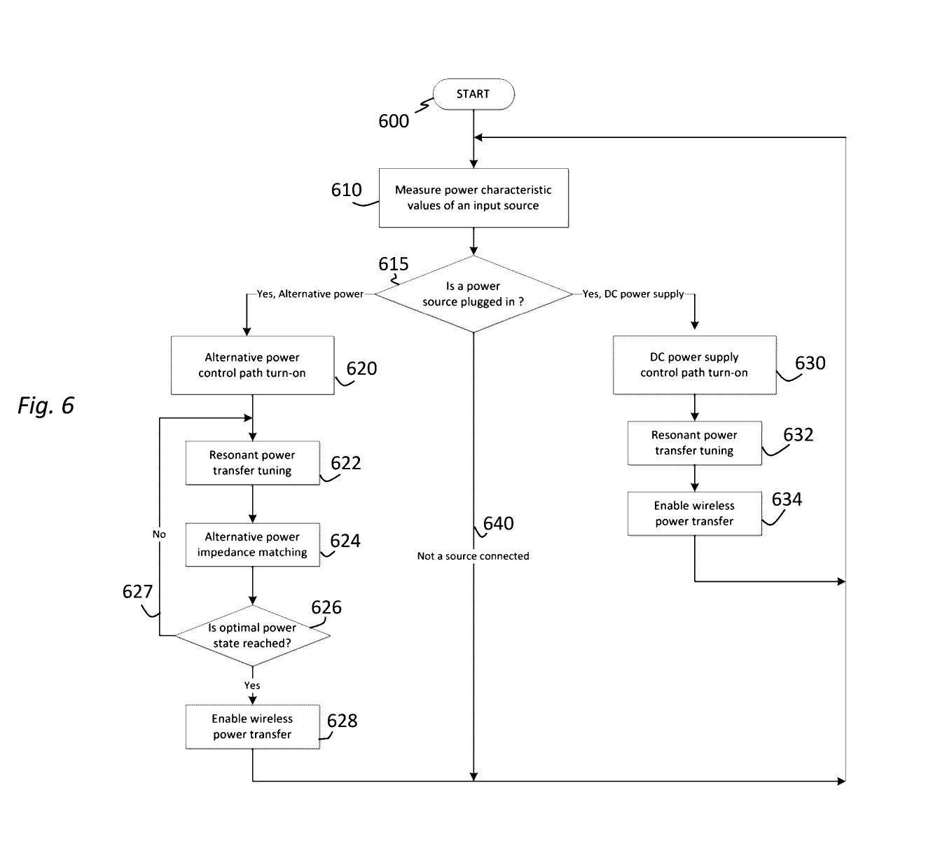

FIG. 6 shows an exemplary flow diagram for implementing an embodiment of the disclosure. The process of FIG. 6 starts at step 600 when the PTU is engaged with a power input source. The power source may be, for example, a battery, an AC/DC adaptor or a source providing harvested power. At step 610, the power characteristic values of the input source are measured. The measured characteristic values may include current, voltage or power. In one embodiment, the measured characteristic values include measuring change in any of current, voltage and/or power. In one embodiment of the disclosure, measuring characteristics value is implemented at a power sensor (e.g., powers sensor 420 in FIG. 4). In another embodiment, measuring characteristics value is implemented at a source determination circuitry (e.g., Source Determination Controller 510, FIG. 5). In still another embodiment, the measured characteristics value is determined in connection with both a power sensor and the source determination circuitry.

Based on the measured characteristic values, at step 615, determination is made as to whether the PTU is connected to a source. If the PTU is not connected to a source, the flow diagram repeats at step 610. This loop may be implemented periodically.

If the measured characteristic values indicate that the PTU is connected to a DC source, then the DC power supply control path is engaged at step 630. At step 632, the required resonant power transfer tuning is determined for the given load. This step may be implemented, for example, by a driver control circuitry (e.g., Inverter Driver Control 520, FIG. 5). At step 634, wireless power transfer is enabled by powering and directing the appropriate resonators (e.g., LC Resonator Tank 450, FIG. 4).

If the measured characteristic values indicate that the PTU is connected to an alternative power source, then alternative power control path is engaged (e.g., path 512, FIG. 5) as shown in step 620. At step 622, resonant power transfer tuning is performed to condition incoming power to provide substantially constant voltage output. At step 624, alternative power impedance matching is performed to substantially match the source impedance with the load impedance. Load impedance may be received from the PRU through BLE packets.

For example, step 624 may require adjusting the source impedance to about 250 Ohms to match that of the load impedance. Steps 622 and 624 may be performed at a power matching circuitry (e.g., MPPT Power Impedance Matching 530, FIG. 5). At step 626, determination is made as to whether optimal charging power state is reached; that is, whether resonant power is tuned and matched to the load impedance. If the desired state is not reached, the loop is repeated as indicated by arrow 627. If the desired state is reached, then wireless power transfer is enabled and charging of PRU commences. Process 600 may be repeated continually when a PRU is engaged.

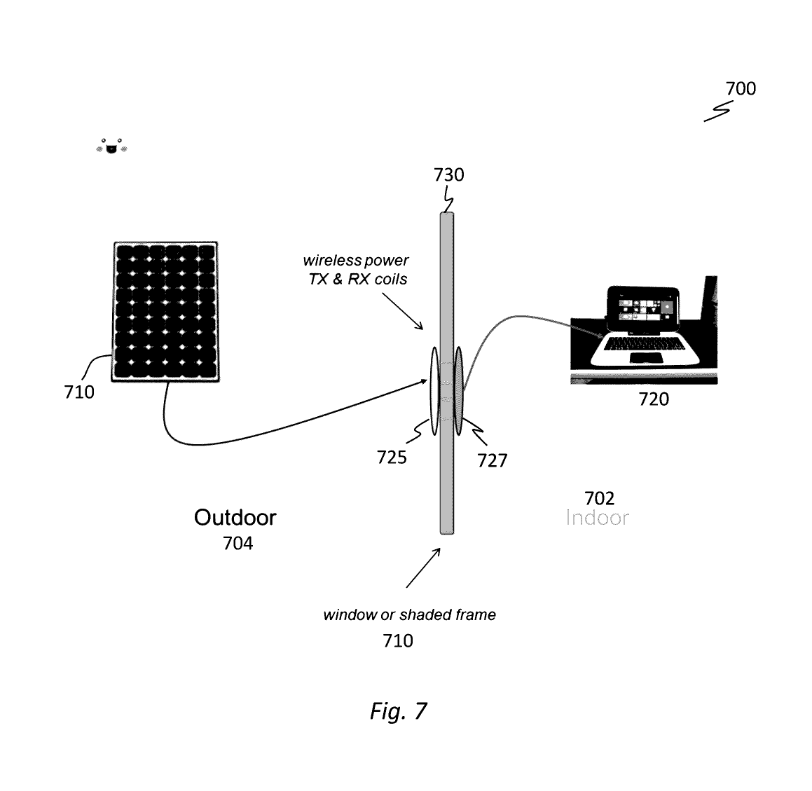

FIG. 7 schematically illustrates wireless charging of a mobile device according to one embodiment of the disclosure. Environment 700 of FIG. 7 includes indoor are 702 and outdoor area 704. Window 730 separates indoor area 702 and outdoor area 704. Solar panel 710 harvests solar energy and provides power input to PTU resonance coil 725. The solar power harvested by the photo-voltaic cell 710 is transferred wirelessly through the resonance coils 725 to PRU resonance coil 727 as coils 725, 727 are placed on both sides of a window or a shaded frame. Thus, a user may use computer 720 indoors while the device is charged with harvesting energy. The illustrate embodiment of FIG. 7 addresses the issue on power device glaring discussed in relation to FIG. 1B.

The following non-exclusive and exemplary embodiments are provided to further illustrate different embodiments of the disclosure. Example 1 is directed to a wireless Power Transmission Unit (PTU), comprising: a controller to receive an input power from one of a plurality of sources, the controller identifying the source of the input power; a matching circuit to receive the input power from the controller, the matching circuit to at least one of condition the input power to a substantially constant voltage or to impedance-match the input power to an impedance-matched output power; and a resonator to receive the impedance-matched power output and to generate a magnetic field to energize an external load.

Example 2 is directed to the PTU of example 1, further comprising a power sensor to receive the input power to detect one or more of voltage or current characteristics of the input power.

Example 3 is directed to the PTU of example 1, further comprising a transmitter tuning circuitry to receive power output form MPPT and adjust the output power level to provide tuned output power.

Example 4 is directed to the PTU of example 3, further comprising an inverter driver controller to receive the tuned output power from the transmitter tuning circuitry and to drive a resonator to energize the external load.

Example 5 is directed to the PTU of example 1, wherein the controller determines a power source as a function of one or more of input power characteristics.

Example 6 is directed to the PTU of example 1, wherein the matching circuit conditions the input power to a substantially constant voltage and impedance-matches the input power the impedance of the external load.

Example 7 is directed to a method to wirelessly energize a Power Receiving Unit (PRU), comprising: receiving an input power from one of a plurality of power sources; identifying the power source as one of substantially linear power profile or a non-linear power profile; conditioning the input power to a substantially constant voltage if the power profile is non-linear; impedance-matching the input power to provide an impedance-matched output power; and generating a magnetic field as a function of the substantially constant voltage and the impedance-matched output power.

Example 8 is directed to the method of example 7, further comprising identifying the power source as one of a DC power source or an alternatively harvested power source.

Example 9 is directed to the method of example 7, wherein identifying the power source further comprises detecting variation in the input power voltage or current.

Example 10 is directed to the method of example 7, further comprising tuning the impedance-matched output power to provide a tuned output power.

Example 11 is directed to the method of example 10, further comprising receiving the tuned output power and driving a resonator to energize an external load.

Example 12 is directed to the method of example 7, further comprising generating the magnetic field to charge an external load across a transparent physical barrier.

Example 13 is directed to the method of example 7, further comprising repeating the steps of conditioning and impedance matching to provide an optimal output power before generating the magnetic field.

Example 14 is directed to the method of example 13, wherein the optimal output power is determined in communication with the external device.

Example 15 is directed to a non-transitory machine-readable medium comprising instructions executable by a processor circuitry to perform steps to wirelessly charge an external device, the instructions cause the processor circuitry to drive operations comprising: receiving an input power from one of a plurality of power sources; identifying the power source as one of substantially linear power profile or a non-linear power profile; conditioning the input power to a substantially constant voltage if the power profile is non-linear; impedance-matching the input power to provide an impedance-matched output power; and generating a magnetic field as a function of the substantially constant voltage and the impedance-matched output power.

Example 16 is directed to the non-transitory machine-readable medium of example 15, wherein the operations further comprise identifying the power source as one of a DC power source or an alternatively harvested power source.

Example 17 is directed to the non-transitory machine-readable medium of example 15, wherein the operations further comprise detecting variation in the input power voltage or current.

Example 18 is directed to the non-transitory machine-readable medium of example 15, wherein the operations further comprise causing tuning the impedance-matched output power to provide a tuned output power.

Example 19 is directed to the non-transitory machine-readable medium of example 18, wherein the operations further comprise energizing the external load as a function of the tuned output power.

Example 20 is directed to the non-transitory machine-readable medium of example 15, wherein the operations further comprise receiving communication from the external load through a communication platform, the communication including impedance requirement of the external load.

While the principles of the disclosure have been illustrated in relation to the exemplary embodiments shown herein, the principles of the disclosure are not limited thereto and include any modification, variation or permutation thereof.

What is claimed is:

1. A wireless Power Transmission Unit (PTU), comprising:
a controller to receive an input power from one of a plurality of sources, the controller identifying the source of the input power;
a matching circuit to receive the input power from the controller, the matching circuit to at least one of condition the input power to a substantially constant voltage or to impedance-match the input power to an impedance-matched output power; and
a resonator to receive the impedance-matched power output and to generate a magnetic field to energize an external load.

2. The PTU of claim 1, further comprising a power sensor to receive the input power to detect one or more of voltage or current characteristics of the input power.

3. The PTU of claim 1, further comprising a transmitter tuning circuitry to receive power output form MPPT and adjust the output power level to provide tuned output power.

4. The PTU of claim 3, further comprising an inverter driver controller to receive the tuned output power from the transmitter tuning circuitry and to drive a resonator to energize the external load.

5. The PTU of claim 1, wherein the controller determines a power source as a function of one or more of input power characteristics.

6. The PTU of claim 1, wherein the matching circuit conditions the input power to a substantially constant voltage and impedance-matches the input power the impedance of the external load.

7. A method to wirelessly energize a Power Receiving Unit (PRU), comprising:
receiving an input power from one of a plurality of power sources;
identifying the power source as one of substantially linear power profile or a non-linear power profile;
conditioning the input power to a substantially constant voltage if the power profile is non-linear;
impedance-matching the input power to provide an impedance-matched output power; and
generating a magnetic field as a function of the substantially constant voltage and the impedance-matched output power.

8. The method of claim 7, further comprising identifying the power source as one of a DC power source or an alternatively harvested power source.

9. The method of claim 7, wherein identifying the power source further comprises detecting variation in the input power voltage or current.

10. The method of claim 7, further comprising tuning the impedance-matched output power to provide a tuned output power.

11. The method of claim 10, further comprising receiving the tuned output power and driving a resonator to energize an external load.

12. The method of claim 7, further comprising generating the magnetic field to charge an external load across a transparent physical barrier.

13. The method of claim 7, further comprising repeating the steps of conditioning and impedance matching to provide an optimal output power before generating the magnetic field.

14. The method of claim 13, wherein the optimal output power is determined in communication with the external device.

15. A non-transitory machine-readable medium comprising instructions executable by a processor circuitry to perform steps to wirelessly charge an external device, the instructions cause the processor circuitry to drive operations comprising:
receiving an input power from one of a plurality of power sources;
identifying the power source as one of substantially linear power profile or a non-linear power profile;
conditioning the input power to a substantially constant voltage if the power profile is non-linear;
impedance-matching the input power to provide an impedance-matched output power; and
generating a magnetic field as a function of the substantially constant voltage and the impedance-matched output power.

16. The non-transitory machine-readable medium of claim 15, wherein the operations further comprise identifying the power source as one of a DC power source or an alternatively harvested power source.

17. The non-transitory machine-readable medium of claim 15, wherein the operations further comprise detecting variation in the input power voltage or current.

18. The non-transitory machine-readable medium of claim 15, wherein the operations further comprise causing tuning the impedance-matched output power to provide a tuned output power.

19. The non-transitory machine-readable medium of claim 18, wherein the operations further comprise energizing the external load as a function of the tuned output power.

20. The non-transitory machine-readable medium of claim 15, wherein the operations further comprise receiving communication from the external load through a communication platform, the communication including impedance requirement of the external load.
